(19) United States
(12) Patent Application Publication
(10) Pub. No.: US 2016/0031380 A1
(43) Pub. Date: Feb. 4, 2016

(54) Storage Assembly

(71) Applicants: Robert R. Guidolin, Bloomingdale, IL (US); Greg Guidolin, Bloomingdale, IL (US)

(72) Inventors: Robert R. Guidolin, Bloomingdale, IL (US); Greg Guidolin, Bloomingdale, IL (US)

(21) Appl. No.: 14/449,951

(22) Filed: Aug. 1, 2014

(51) Int. Cl. B60R 11/00

(52) U.S. Cl. CPC B60R 11/00; B60R 2011/0003; B60R 2011/005

(57) ABSTRACT

A storage assembly for retaining an electronic device on a vehicle minor so the electronic device does not impede a driver's view includes a mount operationally coupled to a vehicle mirror. A rail is operationally coupled to the mount. The rail extends downwardly from the vehicle minor. A basket is operationally coupled to the rail. The basket is positioned below a threshold of the vehicle's windshield. The basket contains the electronic device. The electronic device is accessible to the driver.

### BACKGROUND OF THE DISCLOSURE

### Field of the Disclosure

The disclosure relates to storage devices and more particularly pertains to a new storage device for retaining an electronic device on a vehicle minor so the electronic device does not impede a driver's view.

### SUMMARY OF THE DISCLOSURE

An embodiment of the disclosure meets the needs presented above by generally comprising a mount operationally coupled to a vehicle mirror. A rail is operationally coupled to the mount. The rail extends downwardly from the vehicle mirror. A basket is operationally coupled to the rail. The basket is positioned below a threshold of the vehicle's windshield. The basket contains the electronic device. The electronic device is accessible to the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an in-use view of a storage assembly according to an embodiment of the disclosure.

FIG. 2 is a front view of an embodiment of the disclosure.

FIG. 3 is a left side view of an embodiment of the disclosure.

FIG. 4 is a perspective view of an embodiment of the disclosure.

FIG. 5 is a front view of an alternative embodiment of the disclosure.

### DESCRIPTION OF THE PREFERRED EMBODIMENT

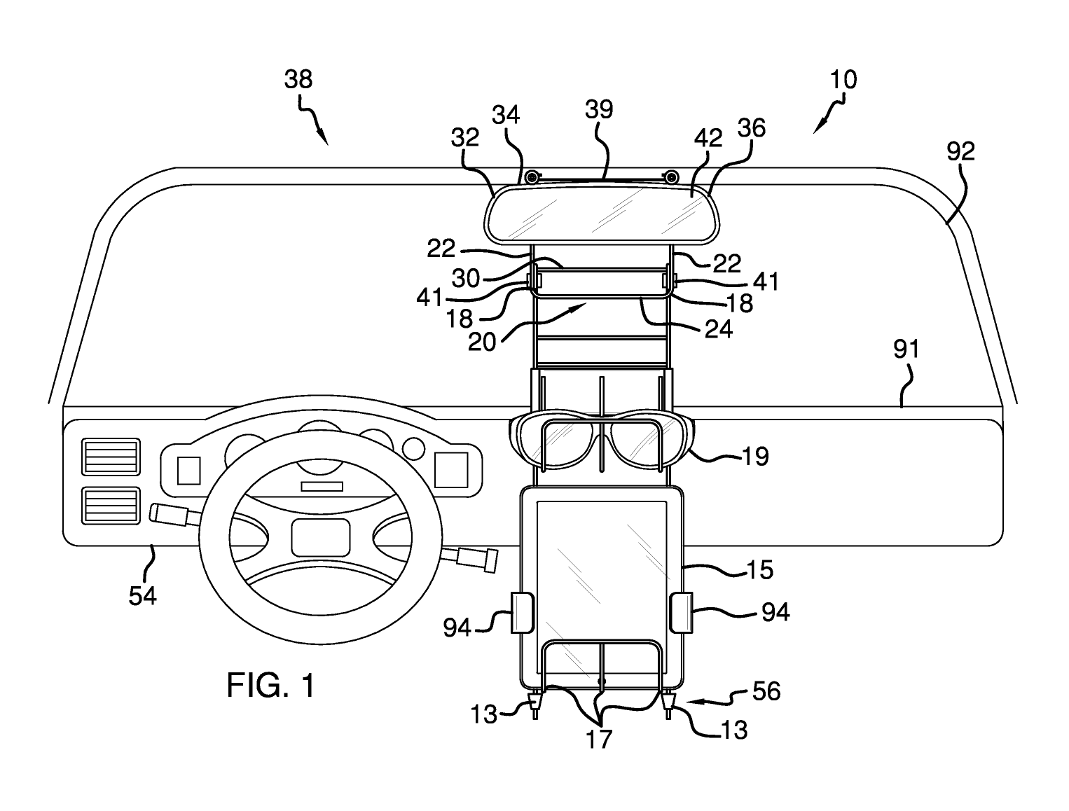

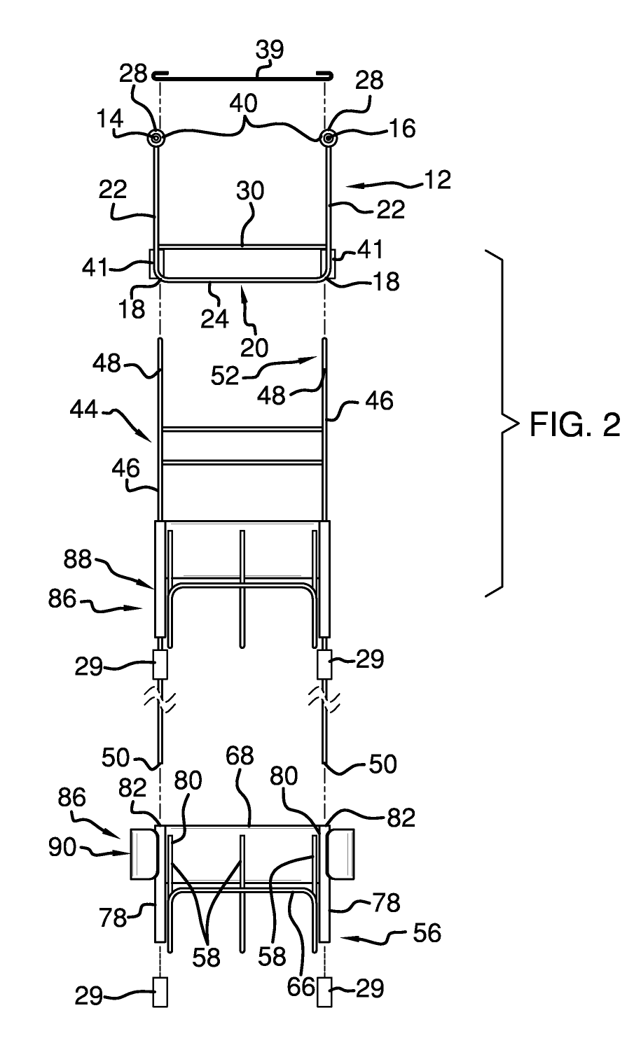

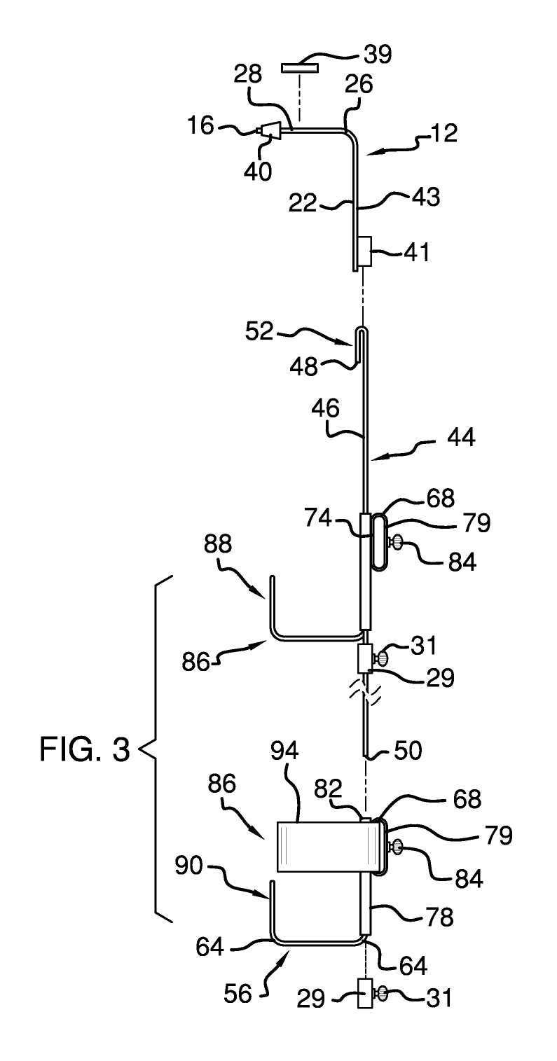

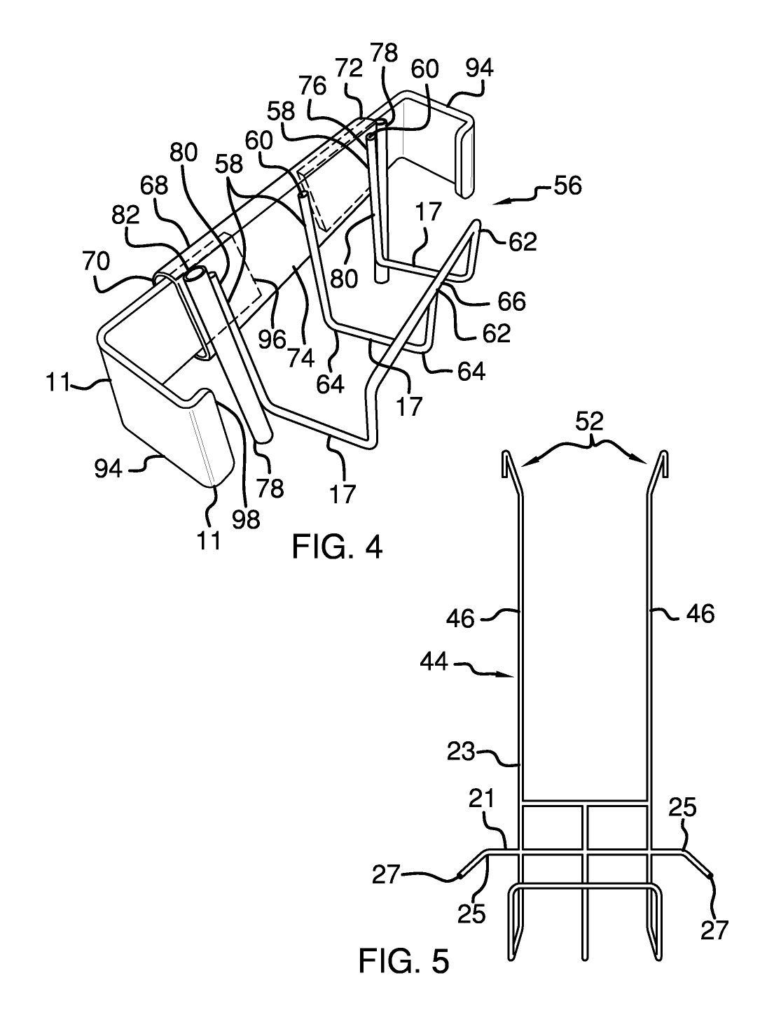

With reference now to the drawings, and in particular to FIGS. 1 through 5 thereof, a new storage device embodying the principles and concepts of an embodiment of the disclosure and generally designated by the reference numeral 10 will be described.

As best illustrated in FIGS. 1 through 5, the storage assembly 10 generally comprises a mount 12 that has a first end 14 and a second end 16. The mount 12 is elongated between the first 14 and second 16 ends. The mount 12 has a pair of primary bends 18 thereon that are evenly spaced apart from a center 20 of the mount 18. The pair of primary bends 18 defines a pair of longitudinal sections 22 of the mount 12 extending upwardly from a central section 24 of the mount 12.

The mount 12 has a pair of secondary bends 26 thereon that is each positioned between an associated one of the first 14 and second 16 ends of the mount 12 and the pair of primary bends 18. The pair of secondary bends 26 defines a pair of lateral sections 28 of the mount 12 extending forwardly from the pair of longitudinal sections 22 of the mount 12. A medial arm 30 extends between each of the pair of longitudinal sections 22 of the mount 12. The medial arm 30 is spaced upwardly from the central section 24 of the mount 12.

The mount 12 is positionable on a vehicle mirror 32. Each of the pair of lateral sections 28 of the mount 12 abuts a top edge 34 of the vehicle minor 32. The pair of longitudinal sections 22 of the mount 12 extends downwardly along a back side 36 of the vehicle mirror 32. The vehicle 38 may be a passenger vehicle of any conventional design. Additionally, the vehicle mirror 32 may be a rear view minor.

A first pair of stoppers 40 each insertably receives an associated one of the first 14 and second 16 ends of the mount 12. Each of the first pair of stoppers 40 is positioned on an associated one of the pair of lateral sections 28 of the mount 12. The first pair of stoppers 40 each engages a front side 42 of the vehicle mirror 32 when the mount 12 is positioned on the vehicle mirror 32. The first pair of stoppers 40 prevents the mount 12 from falling rearwardly off of the vehicle minor 32.

A rail 44 is provided. The rail 44 includes a pair of lengthwise arms 46 that each has an upper end 48 and a lower end 50. Each of the pair of lengthwise arms 46 of the rail 44 is laterally spaced apart. Each of the pair of lengthwise arms 46 of the rail 44 is bent downwardly proximate the upper end 48 of each of the lengthwise arms 46 of the rail 44. The upper end 48 of each of the lengthwise arms 46 of the rail 44 forms a hook 52.

The hook 52 on each of the pair of lengthwise arms 46 of the rail 44 engages the medial arm 30 of the mount 12. The rail 44 is removably coupled to the mount 12. Additionally, the rail 44 extends downwardly from the vehicle minor 32. The rail 44 is positioned in front of a dashboard 54 in the vehicle 38.

A basket 56 is provided. The basket 56 includes a plurality of longitudinal rods 58 that each has a primary end 60 and a secondary end 62. The plurality of longitudinal rods 58 is elongated. Moreover, the plurality of longitudinal rods 58 is laterally spaced apart from one another.

The plurality of longitudinal rods 58 of the basket 56 each has a pair of bends 64 thereon. The plurality of longitudinal rods 58 of the basket 56 has a J-shape. A lateral rod 66 of the basket 56 is coupled to the secondary end 62 of each of the plurality of longitudinal rods 58 of the basket 56. The lateral rod 66 of the basket 56 extends between each of the plurality of longitudinal rods 58 of the basket 56.

A sleeve 68 has a basic end 70 and a following end 72. The sleeve 68 is elongated. Each of the basic 70 and following 72 ends of the sleeve 68 is open. A front side 74 of the sleeve 68 is coupled to and extends laterally along a back side 76 of each of the plurality of longitudinal rods 58 of the basket 56. The sleeve 68 is positioned proximate the primary end 60 of each of the plurality of longitudinal rods 58 of the basket 56.

A pair of tubes 78 is each coupled to and is coextensive with each of an outermost pair 80 of the plurality of longitudinal rods 58 of the basket 56. An uppermost end 82 of each of the pair of tubes 78 is positioned proximate the primary end 60 of the outermost pair 80 of the plurality of longitudinal rods 58 of the basket 56. The pair of tubes 78 insertably receives the lower end 50 of an associated one of the pair of lengthwise arms 46 of the rail 44. The basket 56 is slidably coupled to the rail 44.

A pair of fasteners 84 each extends through a back side 79 of the sleeve 68. Each of the pair of fasteners 84 is positioned proximate an associated one of the basic 70 and following 72 ends of the sleeve 68. The pair of fasteners 84 may each be thumb screws of any conventional design.

The basket 56 is one of a pair of the baskets 86. A first one of the pair of baskets 88 is centrally positioned on the rail 44. A second one of the pair of baskets 90 is positioned proximate the lower end 50 of the rail 44. The second basket 90 is positioned below a threshold 91 of the vehicle's windshield 92.

A pair of clamps 94 is provided. Each of the pair of clamps 94 has a coupled end 96 and a free end 98. The pair of clamps 94 each has a pair of bends 11 thereon. Each of the pair of clamps 94 has a C-shape. The coupled end 96 of each of the pair of clamps 94 is inserted into an associated one of the basic 70 and following 72 ends of the sleeve 68 on the second basket 90. The pair of fasteners 84 on the second basket 90 engages each of the pair of clamps 94 so the pair of clamps 94 are retained at a selected position.

A second pair of the stoppers 13 insertably receives the lower end 50 of an associated one of each of the pair of lengthwise arms 46 of the rail 44. Each of the second pair of stoppers 13 on the rail 44 prevents the second basket 90 from falling off of the lower end 50 of the rail 44. An electronic device 15 is positionable within the second basket 90. The electronic device 15 rests on a middle portion 17 of each of the plurality of longitudinal rods 58 of the second basket 90.

The electronic device 15 is accessible to a driver. The electronic device 15 may be a Smart Phone of any conventional design. An object 19 is positionable in the first basket 88. The object 19 may be a pair of sunglasses or other similar non-electronic object.

In an alternative embodiment, the hook 52 each of the lengthwise arms 46 of the rail 44 is removably coupled to the vehicle minor 32. The basket 56 is permanently coupled to the lower end 50 of the rail 44. A retaining rod 21 extends along a rear side 23 of each of the pair of lengthwise arms 46 of the rail 44. Additionally, the retaining rod 21 has a pair of bends 25 thereon so each end 27 of the retaining rod 21 is directed forwardly from each of the pair of lengthwise arms 46 of the rail 44. The retaining rod 21 retains the electronic device 15 within the basket 56.

In use, the mount 12 is removably coupled to the vehicle mirror 32 and the rail 44 is removably coupled to the mount 12. Each of the first 88 and second 90 baskets is positioned on the rail 44. The pair of clamps 94 on the second basket 90 are positioned so the pair of clamps 94 each engage the electronic device 15 in the second basket 90. The pair of clamps 94 retains the electronic device 15 within the second basket 90. Additionally, the assembly 10 positions the electronic device 15 so the driver's view through the windshield 92 is not obstructed by the electronic device 15. The electronic device 15 is further positioned so the electronic device 15 t is easily accessible to the driver.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A storage assembly for retaining an electronic device on a vehicle minor wherein the electronic device does not impede a driver's view, said assembly comprising:
a mount operationally coupled to the vehicle mirror;
a rail operationally coupled to said mount such that said rail extends downwardly from the vehicle mirror; and
a basket operationally coupled to said rail such that said basket is positioned below a threshold of the vehicle's windshield, said basket containing the electronic device such that the electronic device is accessible to the driver.

2. The assembly according to claim 1, further comprising said mount having a first end and a second end, said mount being elongated between said first and second ends.

3. The assembly according to claim 1, further comprising:
said mount having a pair of primary bends thereon being evenly spaced apart from a center of said mount said such that said pair of primary bends defines a pair of longitudinal sections of said mount extending upwardly from a central section of said mount;
said mount having a pair of secondary bends thereon each being positioned between an associated one of said first and second ends of said mount and said pair of primary bends such that said pair of secondary bends defines a pair of lateral sections of said mount extending forwardly from said pair of longitudinal sections of said mount; and
a medial arm extending between each of a pair of longitudinal sections of said mount such that said medial arm is spaced upwardly from a central section of said mount.

5. The assembly according to claim 1, further comprising said mount being positionable on the vehicle mirror such that each of a pair of lateral sections of said mount abuts a top edge of the vehicle mirror having said a pair of longitudinal sections of said mount extending downwardly along a back side of the vehicle mirror.

6. The assembly according to claim 1, further comprising said rail comprising a pair of lengthwise arms each having an upper end and a lower end, each of said pair of lengthwise arms of said rail being laterally spaced apart, each of said pair of lengthwise arms being bent downwardly proximate said upper end of each of said lengthwise arms such that said upper end of each of said lengthwise arms forms a hook.

7. The assembly according to claim 1, further comprising a hook on each of a pair of lengthwise arms of said rail engaging a medial arm of said mount such that said rail is removably coupled to said mount.

8. The assembly according to claim 1, further comprising said basket comprising a plurality of longitudinal rods having a primary end and a secondary end, said plurality of longitudinal rods being elongated, said plurality of longitudinal rods being laterally spaced apart from one another.

9. The assembly according to claim 8, further comprising said plurality of longitudinal rods of said basket each having a pair of bends thereon such that said plurality of longitudinal rods of said basket has a J-shape.

10. The assembly according to claim 1, further comprising a lateral rod of said basket coupled to a secondary end of each of a plurality of longitudinal rods of said basket such that said lateral rod extends between each of said plurality of longitudinal rods.

11. The assembly according to claim 1, further comprising:
a sleeve having a basic end and a following end, said sleeve being elongated, each of said basic and following ends of said sleeve being open; and
a front side of said sleeve being coupled to and extending laterally along a back side of each of a plurality of longitudinal rods of said basket such that said sleeve is positioned proximate a primary end of each of said plurality of longitudinal rods of said basket.

12. The assembly according to claim 1, further comprising:
a pair of tubes each coupled to and being coextensive with each of an outermost pair of a plurality of longitudinal rods of said basket such that an uppermost end of each of said pair of tubes is positioned proximate a primary end of said outermost pair of said plurality of longitudinal rods of said basket;
said pair of tubes insertably receiving a lower end of an associated one of a pair of lengthwise arms of said rail such that said basket is slidably coupled to said rail.

13. The assembly according to claim 1, further comprising said basket being one of a pair of said baskets, a first one of said pair of baskets being centrally positioned on said rail, a second one of said pair of baskets being positioned proximate a lower end of said rail.

14. The assembly according to claim 13, further comprising the electronic device being positionable within said second one of said pair of baskets such that the electronic device rests on a middle portion of each of a plurality of longitudinal rods of said second basket.

15. A storage assembly for retaining an electronic device on a vehicle minor wherein the electronic device does not impede a driver's view, said assembly comprising:
a mount having a first end and a second end, said mount being elongated between said first and second ends, said mount having a pair of primary bends thereon being evenly spaced apart from a center of said mount said such that said pair of primary bends defines a pair of longitudinal sections of said mount extending upwardly from a central section of said mount;
said mount having a pair of secondary bends thereon each being positioned between an associated one of said first and second ends of said mount and said pair of primary bends such that said pair of secondary bends defines a pair of lateral sections of said mount extending forwardly from said pair of longitudinal sections of said mount;
a medial arm extending between each of a pair of longitudinal sections of said mount such that said medial arm is spaced upwardly from a central section of said mount;
said mount being positionable on the vehicle minor such that each of said pair of lateral sections of said mount abuts a top edge of the vehicle minor having said pair of longitudinal sections of said mount extending downwardly along a back side of the vehicle minor;
a rail comprising a pair of lengthwise arms each having an upper end and a lower end, each of said pair of lengthwise arms of said rail being laterally spaced apart, each of said pair of lengthwise arms being bent downwardly proximate said upper end of each of said lengthwise arms such that said upper end of each of said lengthwise arms forms a hook;
said hook on each of said pair of lengthwise arms of said rail engaging said medial arm of said mount such that said rail is removably coupled to said mount, said rail extending downwardly from the vehicle mirror; and
a basket comprising a plurality of longitudinal rods having a primary end and a secondary end, said plurality of longitudinal rods being elongated, said plurality of longitudinal rods being laterally spaced apart from one another;
said plurality of longitudinal rods of said basket each having a pair of bends thereon such that said plurality of longitudinal rods of said basket has a J-shape;
a lateral rod of said basket coupled to said secondary end of each of said plurality of longitudinal rods of said basket such that said lateral rod extends between each of said plurality of longitudinal rods;
a sleeve having a basic end and a following end, said sleeve being elongated, each of said basic and following ends of said sleeve being open;
a front side of said sleeve being coupled to and extending laterally along a back side of each of said plurality of longitudinal rods of said basket such that said sleeve is positioned proximate said primary end of each of said plurality of longitudinal rods of said basket;
a pair of tubes each coupled to and being coextensive with each of an outermost pair of said plurality of longitudinal rods of said basket such that an uppermost end of each of said pair of tubes is positioned proximate said primary end of said outermost pair of said plurality of longitudinal rods of said basket;
said pair of tubes insertably receiving said lower end of an associated one of said pair of lengthwise arms of said rail such that said basket is slidably coupled to said rail;
said basket being one of a pair of said baskets, a first one of said pair of baskets being centrally positioned on said rail, a second one of said pair of baskets being positioned proximate a lower end of said rail such that said second basket is positioned below a threshold of the vehicle's windshield; and
the electronic device being positionable within said second one of said pair of baskets having the electronic device resting on a middle portion of each of said plurality of longitudinal rods of said second basket such that the electronic device is accessible to the driver.
